(19) United States
(12) Patent Application Publication
(10) Pub. No.: US 2005/0015542 A1
(43) Pub. Date: Jan. 20, 2005

(54) Multiple write storage device

(75) Inventor: James L. Kroening, Dakota Dunes, SD (US)

Correspondence Address: Gateway, Inc.;Attention: Scott Charles Richardson, 610 Gateway Drive, MD Y-04, N. Sioux City, SD, 57049, US

(73) Assignee: Gateway, Inc.

(21) Appl. No.: 10/621,149

(22) Filed: Jul. 15, 2003

(51) Int. Cl. G06F 12/00

(52) U.S. Cl. 711/112

(57) ABSTRACT

A command is provided in a disk drive device that enables the device to read data once, then write it twice, into different locations on the drive. The first location is specified in one embodiment, and an offset to a second location is provided. Once the first copy is written, the second copy is also written to the second location without reading the data a second time.

### REFERENCE TO RELATED APPLICATIONS

This application is related to U.S. Pat. No. 5,966,732, the description of which is hereby incorporated by reference.

### FIELD OF THE INVENTION

The present invention relates to writing information on storage devices, and in particular to writing data twice on a disk drive from a single read of the data.

### BACKGROUND OF THE INVENTION

Computer systems are currently sold with an extra copy of software or other information in a protected area of a disk drive in the system. This extra copy can be used to restore the computer system to a state equivalent to when it left the manufacturer. The protected area is protected from access by the user, while an unprotected area from which the computer normally operates is accessible to the user. Sometimes the user, or events outside the control of the user will cause the software to be modified such that the computer system no longer operates properly. The extra copy can then be used to restore the system.

To write two copies of the software and other data, disk drives normally read the data from another storage device, place the data in a write buffer, write the data, then erase the buffer so it is available for the next data to be written. This creates an additional time burden during manufacture, since the data must again be read, and then written to the protected area.

There is a need to speed the process of writing multiple copies of data in disk drive devices.

### SUMMARY OF THE INVENTION

A command is provided in a disk drive device that enables the device to read data once, then write it twice, into different locations on the drive. The first location is specified in one embodiment, and an offset to a second location is provided. Once the first copy is written, the second copy is also written to the second location without reading the data a second time.

### BRIEF DESCRIPTION OF THE DRAWINGS

FIG. 1 is a block diagram of an example computer for implementing certain aspects of the present invention.

FIG. 2 is a block flow diagram of an example of identifying commands to write to dual locations in a storage device.

FIG. 3 is a simplified block diagram of a disk drive with controller.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

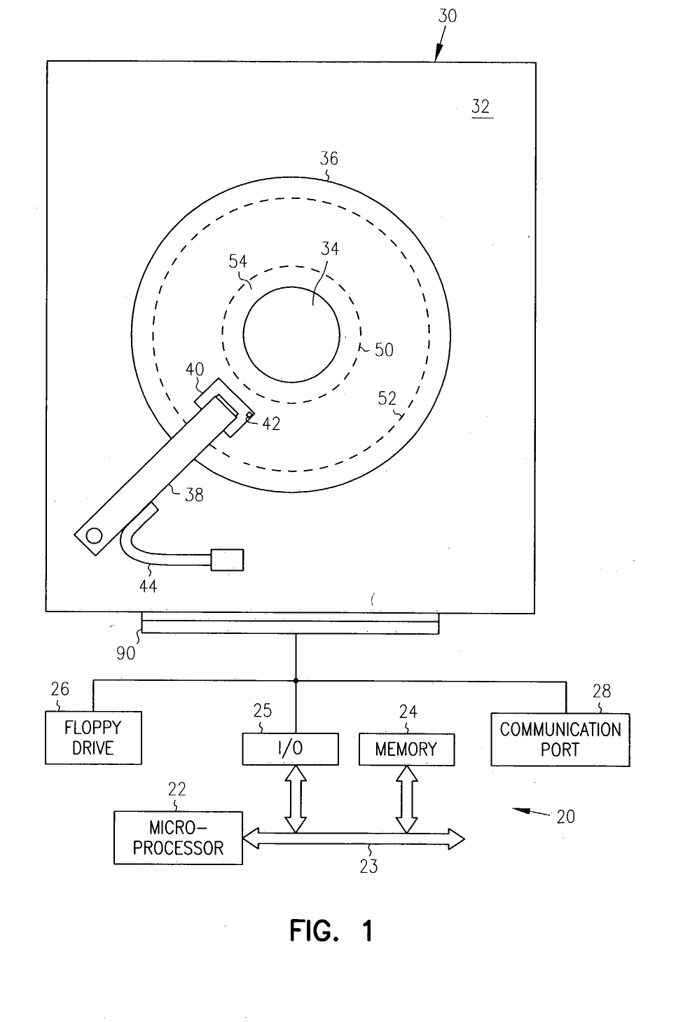

In FIG. 1, a computer system 20 includes a disk drive 30. The computer system 20 also comprises a microprocessor 22 having a data and instruction bus 23 for passing commands and data. A memory 24 and an input/output controller 25 are attached to the data and instruction bus 23. Attached to the input/output controller 25 is a floppy drive 26, a communications port 28 and a disk drive 30. The disk drive 30 shown is a hard or rigid disk drive. The rigid disk drive includes a housing 32 which typically includes a base plate and a cover which form a controlled environment called a disk enclosure. A spindle 34 is attached to the housing. Attached to the spindle 34 is a rigid disk 36. The spindle 34 is capable of rotation and rotates the disk 36 during operation.

Also attached to the housing 32 is an actuator arm 38. In FIG. 1, the actuator arm is shown as rotatably attached to the housing 32, however, an actuator arm can also be attached to the housing 32 so that linear motion is achieved. Attached at the end of the actuator arm 38 is a slider 40 which carries a transducer 42. The slider 40 passes over the disk 36 and places the transducer in transducing relationship to the disk 36. The disk 36 includes a multiplicity of tracks which are typically invisible to the naked eye. The actuator arm 38 is moved and controlled to place the transducer 42 over a particular desired track and then maintain the transducer 42 over the desired track until desired information is read from or written to the desired track. In the case of reading information from the track on the disk 36, the transducer is electrically connected to circuitry 44 for amplifying the signal, decoding the signal and transferring the signal to a connector 90. The electrical circuitry 44 typically includes a circuit board which contains processing circuitry, firmware and other hardware.

An inner track 50 and an outer track 52 are shown as dotted concentric circles on the disk in FIG. 1. The reason these are shown as dotted circles are that the tracks are typically invisible to the naked eye. The inner track 50 and the outer track 52 are just two of a multiplicity of tracks. The tracks located between the inner track 50 and the outer track 52 represent an area of the disk to which a user has access. The outer track is numbered track zero (track 0), the tracks are then numbered consecutively so that the higher numbered tracks are located closer to the center of the disk 36. It should be noted that when a disk drive contains more than one disk, the tracks that share the same number are at about the same distance from the center of the spindle. The tracks having the same number are then said to form a cylinder. The various tracks would be circles on the cylinder.

A reserve area 54, which the user typically can not access, can be located anywhere on the disk 36. A computer's operating system does not comprehend the existence of reserve area 54 because, for example, the operating system operates in accordance with the parameters of a set_max command which is typically set to keep the operating system out of the reserve area 54. As such, a user's access to disk space is dependent on disk topology information provided by the operating system under the constraints of the set_max parameters. Original equipment manufacturers can access and alter the reserve area 54 using an OEM password to the IDE hard drive. User's, however, do to have access to the OEM password and therefore cannot access the reserve area 54. U.S. Pat. No. 5,966,732 is hereby incorporated by reference, at least for its description of reserve areas and methods of interacting with the reserve areas.

The most common location for a reserve area is toward the center diameter of the disk inside of the inner track of the area to which the user has access. Accordingly, the reserve area 54 is shown inside the inner track 50 on the disk 36. The reason that this is the most common portion of the disk on which to have a reserve area is that these tracks hold the least amount of information per track. Since the inner tracks hold less data or information per track they are also in smaller increments. When adding information to the reserve area, the computer manufacturer will determine the size of the information they wish to add. The capacity of all the added tracks for the reserve area will have to be equal to or greater than the size of information to be added to the reserve area. Typically, the computer system manufacturer will add tracks until the amount of storage capacity exceeds the size of the information to add. It should be noted that the tracks capable of holding more information are more valuable in terms of storage available to the user. The tracks capable of holding more information also occur in larger increments. If an additional track is needed to provide enough capacity to meet the capacity desired to be added to the new reserve area, using the tracks having smaller capacity will waste less capacity otherwise available for the user.

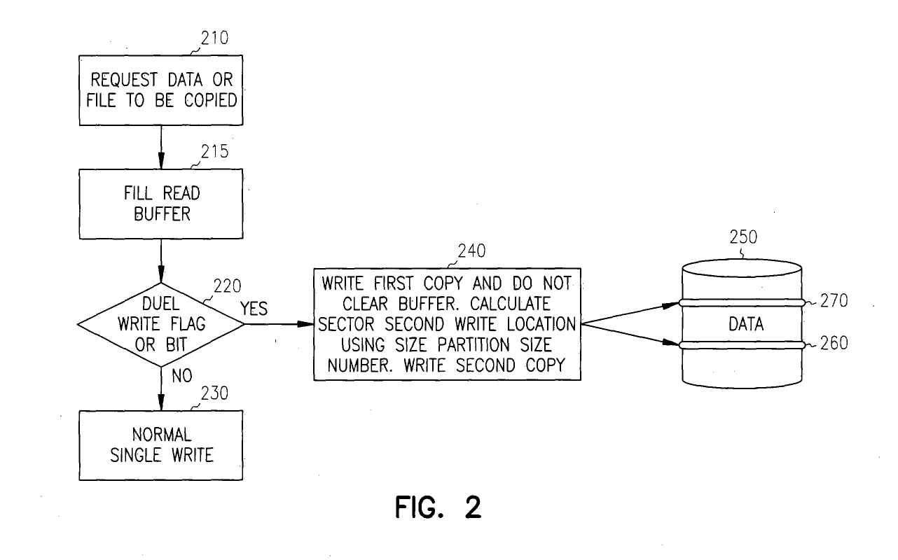

FIG. 2 is a block flow chart showing one example for performing a dual write process. Dual writing is performed by a disk drive having processing capability such as that represented by microprocessor 22 and memory 24 when a request to copy a data or file is received indicating that it should be written in both the user area of the drive and a reserve or protected area of the drive that the user cannot access. Such information commonly consists of factory settings, operating systems, applications and other information that may be needed to restore the computer back to it's original factory settings. In one embodiment, it is important that the user not be able to modify information in the reserve area to preserve the restore ability. Previously, such information was read and written in one area, and then read again, and written in the other area.

In FIG. 2 a request to copy data or a file to the disk drive is received at 210. At 215, the data is read into a read buffer at 215. The read buffer may be filled, or partially filled depending on the amount of data to copy. It may be filled many times during multiple writes for larger files to be copied. At 220, a determination is made whether a dual write flag or bit is set. If not, a normal single write is done as indicated at 230 for each time the read buffer is filled, and after each write, the buffer may be emptied or cleared. In further embodiments, the data to be read contains a header designating a dual write operation. If such a header is read, it is determined that a dual write flag is set at 220.

If the dual write flag is set at 220, the data is written a first time in a normal manner, the buffer is not cleared or emptied, and a second write location is calculated at 240 to determine where the second write is to occur. A write area 250 on the disk drive is used to illustrate the two locations identified at 260 and 270. In one embodiment, location 260 is within the reserve area of the drive, and location 270 is in the user portion of the drive. However, in further embodiments, the copies may be in the same portions of the drive, or yet further different portions.

There are several methods available for calculating the second write location. The address of the second write location may be higher or lower than that of the first write location. In one embodiment, a percentage of the read size of the drive is selected and used to calculate the next address. Such percentage may be any desired percentage, such as one based on the size of the reserve area. The percentage is used in one embodiment to identify a sector, and the second writing begins at the beginning of that sector, or at an offset in the identified sector. In a further embodiment, a user may directly define the distance or range for the second write, such as an even hexadecimal number pointing to a logical block in the storage area.

In one embodiment a dual write function, referred to as a “set double write” is defined in an ATA (Advanced Technology Attachment) controller of the disk drive. It may be implemented as a dual write command in firmware, software and/or hardware. One way to define the set double write is to define an Extended INT 13. Extended INT 13 support for the following extended Function 51 sub-functions allows expansion ATA controller option ROMs to take advantage of the double write feature. The following codes and actions may be utilized to set the double write option, set the address spread, and to clear the double write option.

| Code | Action |
|---|---|
| 80h | Set Double write option |
| 90h | Set write address spread |
| A0h | Clear Double write option |

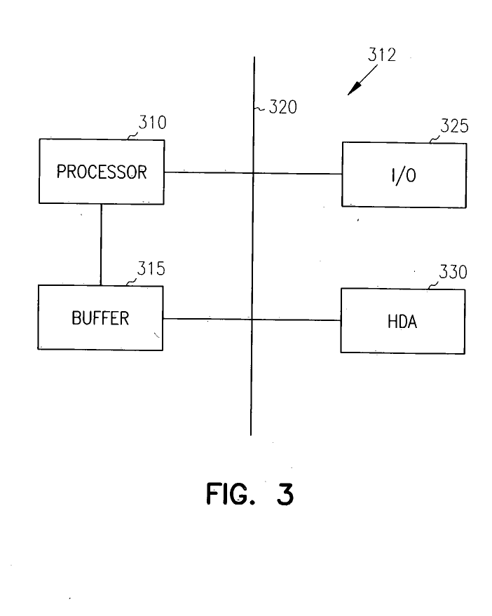

In further embodiments, extensions outside of standards may be used. In one embodiment, these commands are implemented in software running on a processor 310 in a disk drive 312 as shown in FIG. 3 to perform the functions identified in FIG. 2. Selected elements of FIG. 3 comprise the ATA controller for processing the commands. The data to be written is stored in buffer 315, which is coupled to processor 310 and also a bus or other communication path 320 to I/O 325. Commands are received by the processor 310 via I/O 325 or other means as desired. The commands are also issued by the computer system coupled to the disk drive. Data is written from the buffer 315 to a head disk assembly 330, where it is written twice onto the disks per FIG. 2 during a same write cycle. In further embodiments, the data is written to even further locations. Such further locations may be a default backup area of the drive or may be specified by the user or a multiple write command, identifying more than two locations.

While the invention has been described with reference to certain embodiments and examples, it should be understood that the scope of the claims should not be so limited.

1. A method of writing information to a storage device, the method, implemented in the storage device comprising:
receiving a dual write command to write information to the storage device;
determining two locations to write the information;
performing a single reading of the information to be written into a read buffer; and
writing the information to both of the two locations based on the single reading of the information.

2. The method of claim 1 wherein the at least one location is determined based on an address spread within the dual write command.

3. The method of claim 1 wherein the read buffer of the storage device is not cleared between the writing of the information to both of the two locations.

4. The method of claim 3 wherein the information to be read is associated with a bit flag designating a dual write operation.

5. The method of claim 3 wherein the information to be read is proceeded by a file header designating a dual write operation.

6. The method of claim 3 wherein one of the two locations is within a reserve area of the storage device.

7. The method of claim 6 wherein the reserve area is not accessible to a user.

8. The method of claim 1 wherein the two locations are determined based upon a percentage of an address size of the storage device.

9. The method of claim 3 wherein the storage device comprises a disk drive.

10. The method of claim 1 wherein the dual write command is a hard drive firmware command.

11. The method of claim 1 wherein the two locations comprise a first location and a second location based, the second location being upon a calculation performed on the first location.

12. The method of claim 1 wherein the information is written to both of the locations during a same write cycle.

13. The method of claim 1 wherein writing the information to both locations comprises writing the information to a plurality of locations comprising both locations and at least one additional location.

14. A method of writing information to a disk drive storage device, the method comprising:
receiving a command to write information to the storage device;
determining if the command is a dual write command;
if the command is a dual write command:
determining two locations to write the information;
reading the information to be written into a read buffer; and
writing the information to both of the two locations based up a single reading of the information.

15. The method of claim 14 wherein the locations are determined based on an address spread within the dual write command.

16. The method of claim 14 wherein a read buffer of the storage device is not cleared between the writing of information to both of the two locations.

17. The method of claim 14 wherein one location is within a reserve area of the storage device which is not accessible to a user.

18. The method of claim 14 wherein the locations are determined as a percentage of the address size of the storage device.

19. The method of claim 14 wherein data is first written into a location having a lower address than the location at which the data is written a second time.

20. A method of causing a disk drive to write information on storage within the disk drive, the method comprising:
identifying data to be written to two different locations on the disk drive;
generating a command including an identification of the data, a dual write option, and an indication of an offset; and
sending the command to the disk drive.

21. The method of claim 20 wherein a read buffer of the storage device is not cleared between the writing of information to both locations.

22. The method of claim 20 wherein one location is within a reserve area of the storage device which is not accessible to a user.

23. A disk drive having storage media, the disk drive comprising:
means for receiving commands related to writing data;
a controller for processing the received commands;
means for reading data to be written; and
means for writing the same data to two different locations on the storage media based on the received commands while only reading the data once.

24. The disk drive of claim 23 wherein the controller comprises an ATA (Advanced Technology Attachment) controller.

25. A method of causing a disk drive to write information on storage within the disk drive, the method comprising:
identifying data to be written to two different locations on the disk drive;
generating a code selected from the group consisting of set double write, set address spread and clear double write; and
sending the code to the disk drive.

26. The method of claim 25 wherein multiple codes are sent to the disk drive to control the disk drive to write data to two different locations on the disk drive.

27. The method of claim 25 wherein the set double write code commands the disk drive to write following data to two different locations.

28. The method of claim 27 wherein the set address spread code identifies the different between addresses where the data is to be written twice.

29. The method of claim 27 wherein the clear double write code causes the disk drive to return to a single location writing state.
